(19) United States
(12) Patent Application Publication
(10) Pub. No.: US 2016/0228968 A1
(43) Pub. Date: Aug. 11, 2016

(54) Separating Strip Arrangement for a Soldering Nozzle and Soldering Nozzle Device for Selective Wave Soldering

(71) Applicants: ERSA GMBH, Wertheim (DE); ROBERT BOSCH GMBH, Stuttgart (DE)

(72) Inventors: Steffen Schütz, Kreuzwertheim (DE); Simon Hame, Kreuzwertheim (DE); Thomas Huhler, Böttigheim (DE)

(21) Appl. No.: 15/022,632

(22) PCT Filed: Jun. 30, 2014
(86) PCT No.: PCT/EP2014/063844

§ 371 Date: Mar. 17, 2016

(30) Foreign Application Priority Data
Sep. 27, 2013 (DE) 10 2013 110 731.1

(51) Int. Cl. B23K 3/08; B23K 1/08; B23K 3/06

(52) U.S. Cl. CPC B23K 3/08; B23K 3/0653; B23K 1/085

(57) ABSTRACT

The invention relates to an arrangement of at least two solder-wettable separating strips (6, 7) for a soldering nozzle, for simultaneous wave soldering of rows of soldering points, said rows being arranged so as to be spaced apart.

The invention is distinguished by the fact that the depth of the separating strips (6, 7), along the solder influx direction, amounts to at least a multiple of the thickness of the separating strips (6, 7), in order to carry away excess solder from the soldering points by means of surface tension by transfer to the separating strips (6, 7); and also by the fact that the at least two separating strips (6, 7) are oriented exactly parallel to one another and are connected fixedly as a group of separating strips (6, 7) to form a strip assembly (2).

The invention makes it possible to carry out wave soldering with a repeatably high quality and also without the formation of solder bridges even in the case of circuit board structures with a very fine pitch. As compared to known devices for carrying away excess solder from the soldering points during wave soldering, the separating strip arrangement embodied as a strip assembly, in accordance with the invention, additionally makes it possible to considerably reduce the complexity for production, handling, assembly, maintenance, cleaning and renewal, and also the respectively associated costs.

The invention relates to an arrangement of at least two separating strips for a soldering nozzle for selective wave soldering, in accordance with the preamble of claim 1.

It is known to connect, when producing printed circuit board assemblies, the components arranged on the printed circuit board to the printed circuit board by selective wave soldering.

In installations for selective wave soldering, multiple soldering nozzles are habitually arranged, for instance, on a nozzle plate such that the outlet openings of the soldering nozzles, in the soldering position, substantially point to the top in a vertical fashion. In this respect, the cross-section of each soldering nozzle is shaped in a fashion specific to the respective soldering area, and each soldering nozzle is assigned to a particular area to be soldered of the circuit board. For soldering, the soldering nozzle or the nozzle plate having the soldering nozzles arranged thereon is advanced right up to the circuit board to be soldered, from below. In this respect, liquid solder is simultaneously made to flow through the interior of the soldering nozzle from below, said solder exiting at the overhead nozzle opening in the soldering position and wetting the soldering points of the circuit board positioned there such that the desired soldering connection is produced between the component to be soldered—or between the wire projection of the component—and the associated area of the circuit board conductor.

A precise monitoring of all process parameters, such as temperatures, solder flow rates, distances, feed rates etc., is crucial for selective wave to soldering, or for multi-wave soldering with multiple soldering nozzles, in order to obtain high quality soldering points with a high repeatability. A central demand in wave soldering is furthermore that no undesired solder bridges should develop between adjacent soldering points, for instance due to diverted or excess solder, or due to solder beads remaining unintentionally.

In order to guarantee that the stream of solder ends early enough in a defined fashion, which is required hereunto, after a soldering point or a row of soldering points has respectively been wetted or soldered, it is known to arrange, for instance, metal strips made up of a material that can be wetted with solder in the area of the solder wave or soldering nozzle. Said metal strips are moved, during the soldering procedure, in close proximity to the soldering point or to a row of soldering points. In the course of soldering, a connection made up of liquid solder is formed between the soldering point and the metal strip. In this manner, excess solder is to be carried away from the circuit board or from the soldering points, in order to thus prevent undesired solder bridges from developing between adjacent soldering points or adjacent rows of soldering points.

The technical development leads to ever smaller components, component distances and likewise to an ever smaller pitch between adjacent contacts or adjacent pins of components to be soldered in. The known approaches for carrying away excess solder from the soldering point and for inhibiting solder bridges increasingly reach their limits in particular with these ever smaller pitch and component distances. In particular, the problem arises that the known metal strips for carrying away excess solder, with a very small pitch, cannot be repeatably brought up to the respective soldering points or soldering point rows with sufficient accuracy anymore. Mounting or fastening the metal strips to or in the soldering nozzle likewise is an ever greater problem as the pitch decreases, in particular when a multiplicity or plurality of metal strips is to be connected to the soldering nozzle. These problems are multiplied in that soldering nozzles and in particular metal strips for carrying away excess solder regularly have to be cleaned, maintained or replaced, whereby the aforementioned expenditure for re-positioning and fixing the metal strips in particular is correspondingly multiplied several times.

It is with this in mind that the invention is based on the object of overcoming the problems and restrictions described hereinbefore when carrying away excess solder and when inhibiting solder bridges during selective wave soldering. In particular it is also supposed to become possible to carry away excess solder reliably and repeatably from the soldering points when there is a fine pitch or when there are soldering point rows that are close by one another. Furthermore, handling, maintenance and cleaning of the soldering nozzles as well as of the device for carrying away excess solder are supposed to be simplified considerably.

This object is attained by a separating strip arrangement according to the teaching of claim 1 and by a soldering nozzle device according to the teaching of claim 27. Advantageous embodiments of the invention are the subject-matter of the dependent claims.

The separating strip arrangement in accordance with the present invention is, in an initially known manner, assigned to a soldering nozzle in a soldering installation, wherein the soldering nozzle is geared up for simultaneous selective wave soldering of at least two rows of soldering points, said rows being arranged so as to be spaced apart.

In accordance with the invention, the separating strip arrangement is distinguished by the fact that the depth of the separating strips, along the solder influx direction, amounts to at least a multiple of the thickness of the separating strips, wherein the at least two separating strips of the separating strip arrangement are additionally oriented exactly parallel to one another as a group of separating strips and are connected fixedly to form a strip assembly.

For a start, the invention is based on the applicants' finding that excess solder can successfully repeatably be carried away from a row of soldering points when the mentioned depth of the separating strips amounts to at least a multiple, which means more than twice as much, of its thickness. As the applicants have found, it is only in this way that a sufficient surface tension of the liquid solder is developed in the area of the separating strips, whereby the liquid solder is suctioned off from the soldering point using surface tension and runs over onto the separating strip. Preferably, the separating strips in this respect have a depth of 2 to 12 mm, particularly preferably of 4 to 8 mm.

In order to solve the problems described at the beginning relating to arranging, positioning, fastening, maintaining and cleaning the separating strips, the at least two separating strips of the separating strip arrangement, in accordance with the invention, are additionally oriented as a group exactly parallel to one another and are connected fixedly in a suitable manner to form a strip assembly.

By connecting the separating strips to form a separating strip assembly, handling of the separating strips as well as in particular accuracy and repeatability of the arrangement of the separating strips in the area of the nozzle opening are significantly improved. The precise repeatability of the distances between the separating strips that is decisive in particular with a fine component pitch as well as the tolerances thereof relative to one another, relative to the nozzle opening as well as relative to the circuit board and to the soldering points starts to be able to be represented with the aid of the invention in the first place when there is a fine pitch in production.

Furthermore, the invention also facilitates handling, robustness, assembly, maintenance and disassembly of the separating strips since they do not have to be handled, maintained and assembled in a complex fashion individually anymore. Instead, all these steps can take place, thanks to the invention, with the help of a compact and robust assembly made up of separating strips.

In this manner, expenditure and time for maintenance and cleaning of the soldering nozzle can decisively be reduced, the life span or period of use of the separating strips is increased, and the parallelism as well as positioning accuracy of the separating strips are decisively improved. Furthermore, it can decisively be simplified to fasten or tie the separating strips in the area of the nozzle opening since it is not necessary anymore thanks to the invention, to handle individual sensitive separating strips, but a compact strip assembly can be handled and fastened in the area of the nozzle opening.

For putting the invention into practice, it is, for a start, irrelevant in which manner the separating strips are oriented exactly parallel to one another and are connected to one another. In this way, it is envisaged in accordance with a possible embodiment to rivet or screw the separating strips together, for instance, wherein ring-shaped spacers, for instance, which are arranged on the rivets or screws, in each instance ensure that the separating strips are oriented exactly parallel to one another, and are also connected fixedly to one another.

In accordance with embodiments of the invention alternative to the above as well as particularly preferred embodiments, the separating strips, together with at least one bridge connecting the separating strips, and/or together with a frame connecting the separating strips and being at least partially circumferential, are embodied as a one-piece strip assembly.

The fact that the separating strips are embodied in one piece in such a way, together with a connecting bridge or frame, leads to the strip assemblies being producible in a particularly simple and cost-effective fashion since an assembly from individual separating strips, as well as spacers and connecting elements, is not needed for a start.

Further improvements relating to keeping and repeatability of the dimensions and tolerances of the strip assembly ensue due to the one-piece embodiment of the separating strip assemblies, in particular when there is a fine pitch, but also improvements relating to the planarity of the boundary surfaces of the strip assembly, improvements relating to the tolerances between the strip assembly and its reception at or in the nozzle opening and a reduction in the risk of the strip assembly getting jammed or getting stuck in the nozzle opening and of the nozzle opening getting damaged thereby. Exchanging, maintaining and cleaning the strip assembly is equally facilitated, and not least activating, tinning or wetting the separating strip surfaces, which might be required, and thus also the reusability of the strip assembly is facilitated.

The one-piece strip assembly is preferably manufactured from a solid metal block by removal of material, for instance by milling. In accordance with particularly preferred embodiments of the invention, the one-piece strip assembly is manufactured from a solid metal block by water jet cutting, by wire-electro discharge machining or by laser beam cutting. In this respect, experiments conducted by the applicants have shown that water jet cutting generates a particularly advantageous surface texture for activating or tinning the surface of the separating strips of the strip assembly or for wetting said surface with solder.

It is with this in mind that it is furthermore envisaged in accordance with a preferred embodiment of the invention that the strip assembly consists of steel, preferably of S235/ST37 constructional steel, and has been coated with gold, nickel gold and/or tin, at least in the area of the separating strips. An organic surface protection (OSP) is, according to the applicants' findings, suitable as a coating for the separating strips.

The mentioned material combinations or coatings have shown to be advantageous in view of solder wetting and the required relationship of the surface tensions between the solder and the separating strips, as well as simultaneously in view of little de-alloying and the longest possible service life of the strip assembly, without the necessity of maintenance, cleaning or renewal of the strip assembly in the interim.

The manner in which the strip assembly is assigned to the soldering nozzle or the fashion in which the strip assembly is fastened to the soldering nozzle is, in accordance with the invention, arbitrary for a start, as long as the strip assembly and the soldering nozzle are connected fixedly, but so as to be detachable, to each other.

In accordance with preferred embodiments of the invention, the strip assembly can be inserted into a nozzle opening facing the circuit board, or can be placed on a nozzle opening facing the circuit board. With the latter embodiments, the strip assembly, for instance, can take on the function of the nozzle opening itself. When exchanging the strip assembly, which may become necessary for cleaning after several hours of soldering operation, or for renewal due to wear after several weeks of operating the installation, respectively, the respective nozzle simultaneously hence also obtains a new or cleaned nozzle wall and nozzle opening. Hereunto, the strip assembly may be provided with a frame made up of another material, in particular of a material that cannot be wetted with solder, such as stainless steel, wherein the frame in this case forms the nozzle wall and nozzle opening.

In the embodiment alternative to the above, having a strip assembly that can be inserted into the nozzle opening, it is envisaged in accordance with another preferred embodiment of the invention that a defined gap is arranged at least partially circumferentially between the at least partially circumferential frame of the strip assembly and an inside opening of the soldering nozzle. In this respect, the gap has a width in the order of tenths of a millimeter. This embodiment, which can only be implemented thanks to the possible production accuracy of the inventive strip assembly, has the advantage that the strip assembly can easily and without force be inserted into the nozzle opening or be taken out of the soldering nozzle again, whereby a very quick and thus economic exchange of the strip assembly becomes possible during operation of the soldering installation.

Another preferred embodiment of the invention envisages that a circumferential offset is arranged within the opening of the soldering nozzle, the bottom of the strip assembly being able to come to rest on said offset. In this manner, a defined fit of the strip assembly also results in the axial direction of the soldering nozzle.

In accordance with another embodiment of the invention, an extension, for instance a bolt, is arranged at the nozzle-sided bottom of the strip assembly. The extension, for the purpose of fixing the strip assembly along the axial direction of the soldering nozzle, or along the solder flow direction, can be brought into engagement with a cross bolt for plugging through the nozzle walls in a transverse fashion to the solder flow, or with a screw arranged correspondingly. In this manner, the strip assembly is fixed in the nozzle opening, and the strip assembly is inhibited from being washed out of the nozzle opening due to the pumping effect of the stream of solder. Another connection possibility between the strip assembly and the soldering nozzle or the nozzle opening consists in employing a clamping device, which fixes the strip assembly in the nozzle opening by way of a clamping effect.

In accordance with embodiments alternative to the above, the strip assembly can be fixed in the nozzle opening along the solder flow direction using a resilient latching device, or magnetically. In the case of the magnetic fixation, a magnetic device, for instance a permanent magnet, is preferably arranged at the nozzle-sided bottom of the strip assembly. If the strip assembly consists of steel or of a ferromagnetic material, the material of the strip assembly itself can form the magnetic device corresponding to the nozzle-sided magnetic device. If the strip assembly does not consist of steel or of a ferromagnetic material, a permanent magnet or an element made up of a ferromagnetic material can equally be arranged at the nozzle-sided bottom of the strip assembly. The magnetic devices on the nozzle side and on the strip assembly side attract each other mutually when the strip assembly has been inserted into the nozzle opening, hence retaining the strip assembly in the nozzle against the pumping effect of the stream of solder.

Fixation using a resilient latching device or using a permanent magnet has the advantage of being constructionally simpler than the fixation using longitudinal and cross bolts. Furthermore, the former embodiments have the advantage that the strip assembly can be fixed in the soldering nozzle and likewise can be taken out again without the nozzle having to be accessible from the side hereunto. This is because the fixation, in these embodiments, is already established automatically when the strip assembly is axially pulled into the nozzle opening, and likewise becomes detached by simply withdrawing the strip assembly, for instance with the aid of a gripper tool, in the longitudinal direction of the nozzle. The nozzle wall moreover is not weakened owing to the cross holes through the nozzle not being needed for the bolt solution, and neither is the solder return flow affected at the outer side of the nozzle wall.

In the embodiment having a magnetic fixation of the strip assembly in the nozzle opening, it is preferably envisaged that the tolerances of the vertical stop in the nozzle opening, of the depth of the strip assembly and of the positions of the magnetic devices, along the solder flow direction, are chosen so as to keep an air gap between the strip assembly and the nozzle-sided magnetic device when the strip assembly is in a state inserted into the nozzle opening. In this manner, a redundant dimensioning of the fit of the strip assembly in the nozzle is avoided and thus a fit of the strip assembly free of play is guaranteed. The demands on accuracy relating to the production and arrangement of the vertical stop, to the strip assembly depth as well as to the magnetic device are also reduced hereby, and thus correspondingly the production costs are reduced, too.

In this respect, the magnetic device preferably comprises a permanent magnet received in a metal sleeve. The metal sleeve can be inserted into a recess of the nozzle bottom of the soldering nozzle and can there be deformed in a ductile fashion in the radial direction, for fastening the magnetic device at the nozzle bottom. This means that the magnetic device, similar to a blind rivet, can be connected to the nozzle in a simple and cost-effective fashion, and can also be separated from the nozzle again by being driven out or drilled out.

Another preferred embodiment of the invention envisages that the at least partially circumferential frame of the strip assembly, or the shape of the outer boundary of the strip assembly, just as the associated nozzle opening, features at least one corner area, whose shape differs from the shape of the other corner areas, for instance in such a way that the at least one corner area obtains a corner radius, which substantially differs from the corner radius of the other corner areas. In this manner, it is prevented that the strip assembly is incorrectly inserted into the nozzle opening.

In accordance with another embodiment of the invention, the wall of the soldering nozzle, in the area of the reception for the strip assembly, features at least one recess, but preferably at least two recesses, which is or are open towards the nozzle end. This serves the purpose of the simple exchanging of the strip assembly in such a form that the strip assembly—by engaging the recesses open to the top with one or more gripper tools—can hence simply be withdrawn vertically to the top, from the soldering nozzle.

Another preferred embodiment of the invention envisages that the strip assembly, at its boundary surface facing the circuit board, features an outer edge which is at least partially circumferential. The outer edge has been positioned such that it is flush with a nozzle-sided terminal edge of the soldering nozzle when the strip assembly has been correctly inserted into the nozzle. In this manner, it can be checked in a simple fashion whether the strip assembly has been correctly and completely placed into the nozzle opening.

In accordance with another possible embodiment of the invention, the at least two separating strips feature different depths and/or different positions along the axial nozzle direction or solder flow direction. In this manner, it becomes possible to adapt the strip assembly in the best possible fashion to any vertical contours of the circuit board, or to wire projections appertaining to the components to be soldered and having different sizes.

In accordance with another particularly preferred embodiment of the invention, at least one of the separating strips of the strip assembly (preferably several or all separating strips of a strip assembly) is/are furthermore assigned to a row of soldering points in each instance, in such a way that a virtual longitudinal center plane of the separating strip intersects the circuit board in the centers of the soldering points. In this manner, it is achieved that excess solder is suctioned off in a particularly effective fashion from the respective soldering point row, in that the liquid solder is suctioned off on both sides, in each instance along a surface of the separating strip, owing to the surface tension between the solder and the separating strip surface.

An embodiment alternative to the above envisages that at least one separating strip, preferably several or all separating strips of a strip assembly, is/are assigned to two rows of soldering points in each instance, in such a way that a virtual longitudinal center plane of the respective separating strip centrally intersects the circuit board between the two soldering point rows. In this manner, excess solder of the respective soldering point row is received on both sides by different separating strips and is suctioned off using surface tension.

Further possible embodiments of the invention envisage that the strip assembly comprises at least one group of separating strips arranged diagonally, or a grid-shaped arrangement of at least two criss-crossing groups of separating strips running in parallel in each instance. In this manner, wave soldering can also be performed with particularly complex and/or confined arrangements of soldering points, without undesired solder bridges developing.

The invention furthermore relates to an associated soldering nozzle device having at least one soldering nozzle, having the features of claim 27, for simultaneous selective wave soldering of at least two rows of soldering points, said rows being arranged so as to be spaced apart, in a soldering installation. The soldering nozzle device is distinguished by a strip assembly connectable to the soldering nozzle, as it has been described in view of claims 1 to 26 hereinbefore.

Hereinafter, the invention will be explained in greater detail with the help of drawings only illustrating exemplary embodiments.

In the figures:

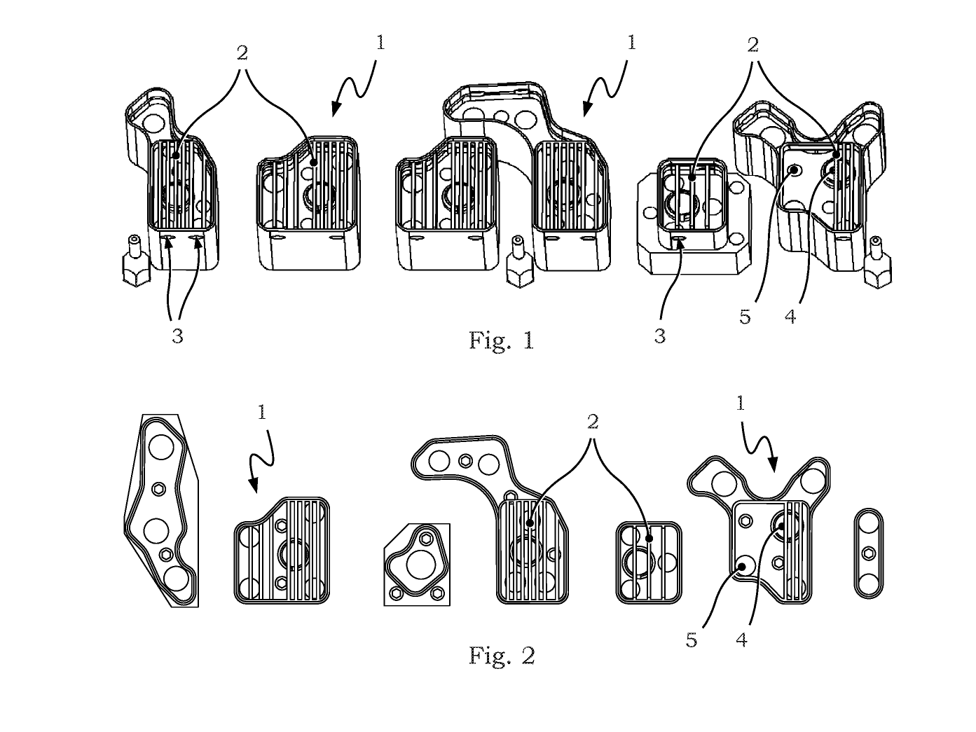

FIG. 1 shows, in an isometric illustration, an arrangement of soldering nozzles for selective wave soldering having separating strip assemblies on a nozzle plate, in accordance with an embodiment of the present invention;

FIG. 2 shows, in the view from above, a nozzle arrangement comparable to the nozzle arrangement in accordance with FIG. 1;

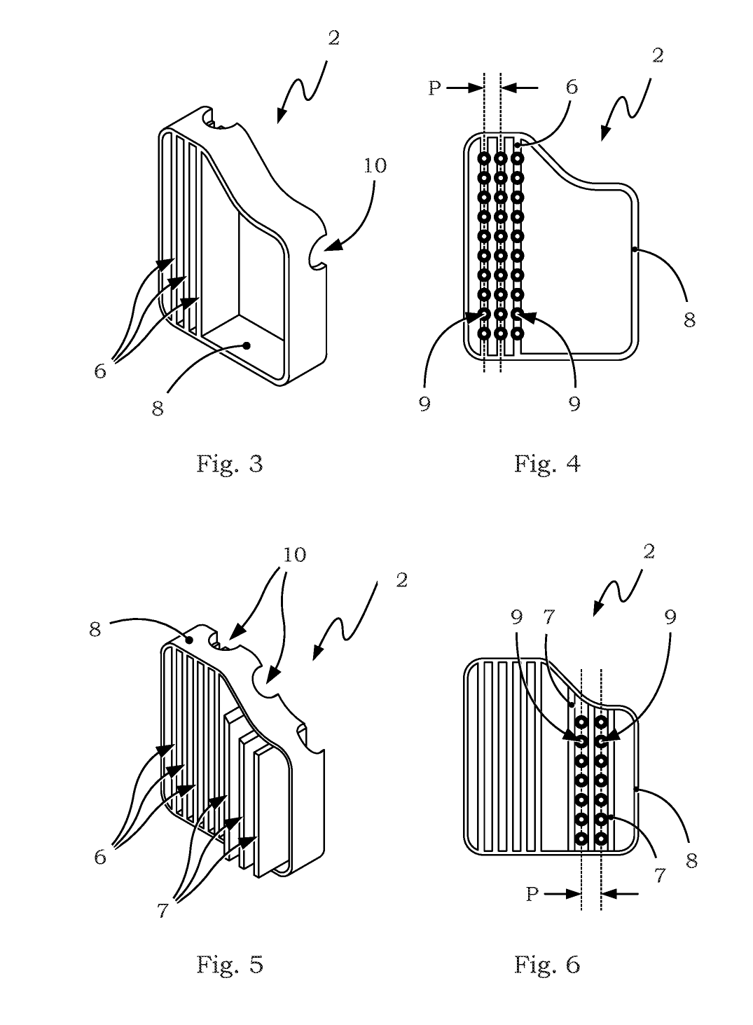

FIG. 3 shows, in an isometric illustration, a strip assembly in accordance with an embodiment of the present invention;

FIG. 4 shows the strip assembly in accordance with FIG. 3 in the view from above;

FIG. 5 shows, in an illustration and view corresponding to FIG. 3, a strip assembly in accordance with another embodiment of the present invention; and

FIG. 6 shows the strip assembly in accordance with FIG. 5 in the view from above.

Each of FIGS. 1 and 2 shows a nozzle arrangement of soldering nozzles 1, of the kind that can be arranged on a nozzle plate (not illustrated) of a soldering installation for selective wave soldering. A plurality of different cross-sectional shapes of the soldering nozzles 1 can be seen. In this respect, the arrangement and the cross-sectional shape of the soldering nozzles 1 in each instance have been adapted in a fashion specific to the product to areas to be soldered on a circuit board (not illustrated).

At least by areas, separating strip assemblies 2 have in each instance been inserted into most of the illustrated soldering nozzles 1. The strip assemblies 2, during the soldering process, are moved up close to the respective soldering point rows on the circuit boards, such that, in the course of soldering, excess solder can be transferred from the soldering point rows to the separating strips of the strip assemblies 2 (said strips being provided with a solder-wettable material surface) and can thus be diverted from the soldering points or circuit boards in order to avoid undesired solder beads or solder bridges on the circuit boards in this way.

Furthermore lateral nozzle discharge openings 3 can be seen, through which excess solder in view of a permanent solder agitation and thus a permanent application of heat can laterally be discharged from the soldering nozzles 1. Magnetic devices 4 which are arranged in the nozzle bottom, and which fix the strip assemblies 2 in the nozzle opening against the pumping effect of the solder flow streaming through holes 5 in the nozzle bottom from below, are equally visible.

FIGS. 3 to 6 show, by way of example, two embodiments of strip assemblies 2 in accordance with the invention, as they are arranged in some of the soldering nozzles 1 in accordance with FIGS. 1 and 2.

Initially, it can be seen that the strip assemblies 2 have been produced in one piece from a solid material, preferably from steel, and that each of them features groups of parallel separating strips 6, 7 as well as a circumferential frame 8.

In particular when the pitch P of the circuit boards to be soldered is particularly fine (as indicated in FIGS. 4 and 6 with the help of the soldering point rows 9) or when the soldering point distance of the components and modules on the circuit board is correspondingly small, the separating strip arrangements 6, 7 preferably, in accordance with the invention, embodied as one-piece assemblies 2 allow for exactly assigning the separating strips 6, 7 to the respective soldering point rows 9.

In FIGS. 4 and 6, in this respect, two different types of assignment or relative positioning between the respective separating strip groups 6, 7 and the soldering point rows 9 are illustrated. In the embodiment in accordance with FIG. 4, the strip assembly 2 is positioned relative to the circuit board (not illustrated) such that a separating strip 6 is in each instance assigned to a row of soldering points 9. This means that excess solder is in this embodiment diverted at each of the soldering points 9, in each instance from the two lateral surfaces of the same separating strip 6, or suctioned off using surface tension.

In the embodiment in accordance with FIG. 6, by contrast, the strip assembly 2 is positioned relative to the circuit board or to the soldering points 9 such that each of the soldering point rows 9 is deposited between two separating strips 7. Consequently, excess solder is diverted or suctioned off at each of the soldering points 9 in accordance with FIG. 6 from opposite side surfaces of two different separating strips 7. In this respect, the embodiment in accordance with FIG. 6 is in particular suitable with larger wire projections of the components to be soldered since the same are then deposited between the separating strips 6 and hence do not collide with the separating strips 6.

Furthermore, handling of the separating strips 6, 7 in the form of assemblies 2 is also considerably simplified, facilitated and speeded up as compared to assembling individual separating elements in the soldering nozzles 1. The separating strip assemblies 2 are considerably more robust and substantially improve the required observing of the dimensions and tolerances relating to the position and the relative location of the separating strips 6, 7 with respect to one another as well as with respect to the circuit board and to the soldering points 9. Maintenance, exchange and cleaning of the separating strips 6, 7 are decisively facilitated and speeded up thanks to the same being embodied as one-piece strip assemblies 2, and the life span of the separating strips 6, 7 is additionally prolonged. The strip assemblies 2 embodied in one piece do not require any complex assembling from various individual parts, corresponding sources of error also falling away.

The strip assembly 2 illustrated in FIGS. 5 and 6 comprises two groups 6, 7 of separating strips, which feature a different width, that is depth referring to the stream of solder. In this manner, for instance, different vertical contours on the circuit board, or wire projections of the components to be soldered, with different sizes, can be taken account of, and the separating strips 6, 7 can be positioned at the best possible or minimum distance to the respective soldering point rows 9 in each instance.

The clearances 10 that can be seen in FIGS. 3 and 5 correspond to the nozzle discharge openings 3 in accordance with FIG. 1, and hence make it possible, in view of a permanent solder agitation and application of heat, that excess solder is discharged to the side without being disturbed.

### LIST OF REFERENCE NUMERALS

1 soldering nozzle
2 strip assembly, separating strip assembly
3 overflow hole
4 magnetic device
5 solder flow hole
6, 7 separating strips, separating strip group
8 circumferential frame
9 soldering point
10 clearance

1. A separating strip arrangement comprising:
at least two solder-wettable separating strips for a soldering nozzle for simultaneous selective wave soldering, wherein the at least two separating strips are oriented parallel to one another and are connected fixedly as a group of separating strips to form a strip assembly; and
at least two rows of soldering points arranged so as to be spaced apart, in a soldering installation, wherein a depth of the separating strips, for generating a surface tension suctioning off excess solder from the soldering points, along a solder influx direction, amounts to at least a multiple of a thickness of the separating strips.

2. The separating strip arrangement according to claim 1, in which the separating strips have a depth of 4 to 8 mm.

3. The separating strip arrangement according to claim 1, in which the separating strips are connected to one another to form a strip assembly with spacers interposed between the separating strips.

4. The separating strip arrangement according to claim 1, in which the separating strips, together with at least one bridge connecting the separating strips, forms a one-piece strip assembly.

5. The separating strip arrangement according to claim 1, in which the separating strips, together with a frame connecting the separating strips, forms a one-piece strip assembly.

6. The separating strip arrangement according to claim 4, in which the strip assembly is a solid metal block with material removed.

7. The separating strip arrangement according to claim 4, in which the the material is removed by water jet cutting, wire-electro discharge machining, or laser beam cutting.

8. (canceled)

9. The separating strip arrangement according to claim 1, in which the strip assembly is steel coated with gold, nickel gold and/or tin, at least in an area of the separating strips.

10. The separating strip arrangement according to claim 1, in which the strip assembly is placed on a nozzle opening.

11. The separating strip arrangement according to claim 1, in which the strip assembly is received into a nozzle opening.

12. The separating strip arrangement according to claim 11, in which a defined gap with a width in the order of tenths of a millimeter is arranged at least partially circumferentially between a frame of the strip assembly and an inside opening of the soldering nozzle.

13. The separating strip arrangement according to claim 11, in which an offset that is at least partially circumferential is arranged within the opening of the soldering nozzle as a vertical stop for resting of the strip assembly.

14. The separating strip arrangement according to claim 11, in which an extension, which, for fixing the strip assembly along the solder flow direction, can be brought into engagement with a cross bolt for plugging through the nozzle walls in a transverse fashion to the solder flow, is arranged at the nozzle-sided bottom of the strip assembly.

15. The separating strip arrangement according to claim 11, in which the strip assembly is fixed in the nozzle opening along the solder flow direction using a resilient latching device.

16. The separating strip arrangement according to claim 11, in which magnetic devices corresponding to one another for fixing the strip assembly along the solder flow direction are arranged within the opening of the soldering nozzle and at a nozzle-sided bottom of the strip assembly.

17. The separating strip arrangement according to claim 16, in which tolerances of the vertical stop, of the depth of the strip assembly and of the vertical positions of the magnetic devices are chosen so as to keep an air gap between the magnetic devices when the strip assembly is in a state inserted into the nozzle opening.

18. The separating strip arrangement according to claim 16, in which the at least one of the magnetic devices includes a permanent magnet received in a metal sleeve, wherein the metal sleeve can be inserted into a recess of the nozzle bottom and can be radially deformed in a ductile fashion for fastening the at least one of the magnetic devices in the recess.

19. The separating strip arrangement according to claim 5, in which the frame of the strip assembly features at least one corner area, whose shape differs from the shape of other corner areas.

20. The separating strip arrangement according to claim 11, in which a wall of the soldering nozzle, in the area of the reception for the strip assembly, features at least one recess that is open towards the nozzle end.

21. The separating strip arrangement according to claim 11, in which the strip assembly, at its boundary surface, features an outer edge which is at least partially circumferential, and which is flush with a nozzle-sided terminal edge of the soldering nozzle when the strip assembly is inserted into the nozzle.

22. The separating strip arrangement according to claim 1, in which the at least two separating strips feature different depths and/or different axial positions relating to the soldering nozzle.

23. The separating strip arrangement according to claim 1, in which at least one separating strip is assigned to a row of soldering points, in such a way that a virtual longitudinal center plane of the separating strip can intersects a circuit board in centers of the soldering points.

24. The separating strip arrangement according to claim 1, in which at least one separating strip is assigned to two rows of soldering points, in such a way that a virtual longitudinal center plane of the separating strip can centrally intersects a circuit board between the two soldering point rows.

25. The separating strip arrangement according to claim 1, in which the strip assembly includes at least one group of separating strips arranged diagonally.

26. The separating strip arrangement according to claim 1, in which the strip assembly includes a grid-shaped arrangement of intersecting groups of separating strips running in parallel in each instance.

27. A soldering nozzle device comprising:
a soldering nozzle for simultaneous selective wave soldering of at least two rows of soldering points, said rows being arranged so as to be spaced apart, in a soldering installation; and
a separating strip arrangement according to claim 1, connected to the soldering nozzle.
